(19) United States
(12) Patent Application Publication
(10) Pub. No.: US 2006/0236613 A1
(43) Pub. Date: Oct. 26, 2006

(54) Thermally broken hanging panel system

(76) Inventor: K. Bradley Ewing, North Vancouver (CA)

Correspondence Address: John Russell Uren, P. Eng., Suite 202, 1590 Bellevue Avenue, West Vancouver, BC, V7V 1A7, CA

(21) Appl. No.: 11/354,625

(22) Filed: Feb. 14, 2006

Related U.S. Application Data
(63) Continuation-in-part of application No. 10/830,893, filed on Apr. 22, 2004.

(51) Int. Cl. E05D 15/06

(52) U.S. Cl. 49/410

(57) ABSTRACT

A hanging panel system which utilizes a bearing assembly for movement in a horizontal plane. The panel system utilizes a load carrying member about the periphery of the panel and an inside and outside material which define the inside and outside surfaces of the panel system. The outside material is thermally isolated from the load carrying member and the inside material. The load carrying member is conveniently steel.

### CROSS-REFERENCE TO RELATED APPLICATION

This application is a continuation-in-part of application Ser. No. 10/830,893 filed Apr. 22, 2004 entitled SUSPENSION AND SILL SYSTEM FOR SLIDING MEMBERS and presently co-pending herewith.

### INTRODUCTION

This invention relates to a thermally broken hanging panel system and, more particularly, to a thermally broken hanging panel system for heavy panels which are exposed to adverse and exterior weather conditions.

### BACKGROUND OF THE INVENTION

Exterior sliding doors or panels which are opened and closed by sliding within a groove and which are maintained in their generally vertical position during the sliding movement are ubiquitous in residential and commercial construction. However, disadvantages in the use and installation of such panels are well known. First, if the sliding members are heavy, hanging such members is difficult and two or more specialized installers may be required. Second, continued and proper adjustment of the sliding panels is important for proper operation of the panels or doors and, again, skilled labor may not be readily available. Third, existing sliding members generally have their entire weight acting on bearings located on the bottom of the door which run on a rail. The rail is raised from the surface of the exterior and interior floors which causes access problems for carts and disabled users. The bearings, being on the bottom of the door, attract water and other debris which contacts the door and falls downwardly into the bearing area over time. The debris may enter the bearings, prohibit smooth movement of the doors and cause premature wear. In an effort to prevent this contamination, friction brushes are often used which, in turn, interfere with the smooth movement of the sliding members. Fourth, the weight of such doors may act in an unbalanced way on the bearings if they are not precisely positioned. Thus, one set of bearings may receive more loading than a second set of bearings which affects the operation of the doors and the bearing life. Finally, subsequent service to the sliding members after installation typically requires a number of service personal to raise the doors off their track for cleaning, item replacement and the like. Thereafter, the panel members will require installation and adjustment. This is unnecessarily expensive, time consuming and inconvenient for the user.

### SUMMARY OF THE INVENTION

According to one aspect of the invention, there is provided a hanging panel system having at least one panel which moves in a substantially horizontal plane with said panel in a substantially vertical position, said panel system having a hanging assembly on the upper end of said movable panel to allow said movement in said substantially horizontal plane, said panel member having a load bearing member extending around the circumference of said panel, said panel having an outside and an inside surface, said outside surface being thermally isolated from said load bearing member and said inside surface, said load bearing member being made from steel material.

According to a further aspect of the invention, there is provided a method of manufacturing a hanging panel member operable to be connected to a hanging and movable bearing assembly, said method comprising the steps of locating a load bearing member so as to define the general circumference of said panel member, operatively connecting an inside and an outside surface material to said load bearing member, thermally isolating said outside surface material from said load bearing member and said inside surface material and utilizing steel material for said load bearing member.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic isometric and cutaway view of two (2) adjacent sliding doors moving within adjacent drain tubes and which sliding doors incorporate the teachings of the present invention;

FIG. 2 is a diagrammatic end view of the sliding doors particularly showing the bearing mounting and the sill construction in which the sliding doors are guided according to a further aspect of the invention;

FIGS. 3A and 3B are partial and diagrammatic front and side views, respectively, of a door panel according to a further aspect of the invention which particularly illustrates the steel core extending about the periphery of the door panel;

FIG. 4 is a diagrammatic sectional view taken along IV-IV of FIG. 3 and which further illustrates an adjacent door panel according to the invention;

FIG. 5 is a diagrammatic sectional view of a pair of door panels taken along V-V of FIG. 3 and which particularly illustrates the door panels of FIG. 4 at the bottom of the door panels running in the door guide; and

FIG. 6 is a diagrammatic sectional view taken along VI-VI in FIG. 3 and which particular illustrates the vertical members of the door panel according to the invention.

### DESCRIPTION OF SPECIFIC EMBODIMENT

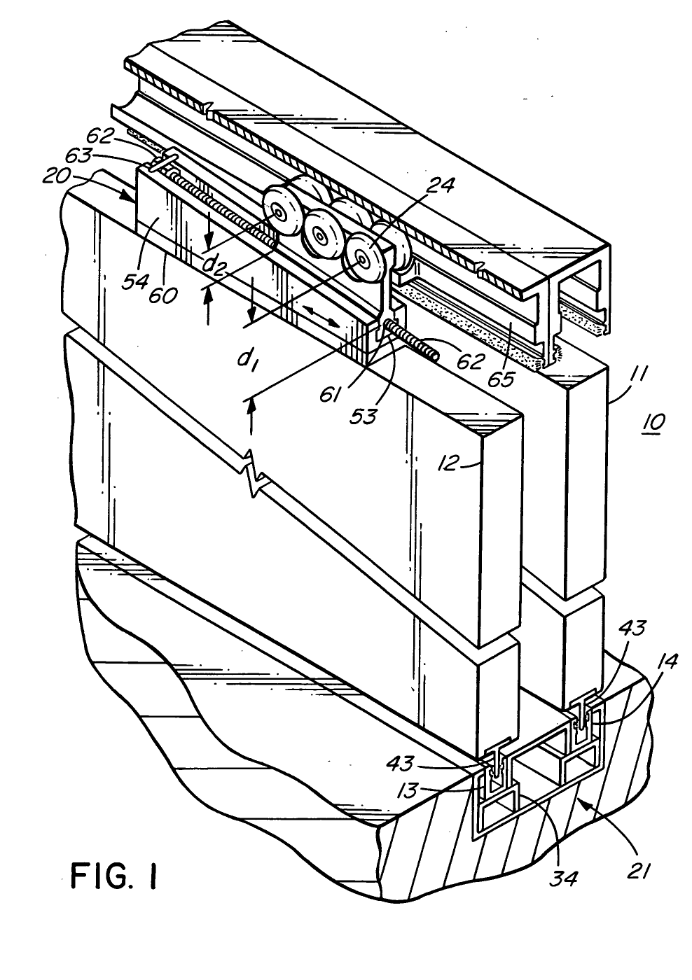

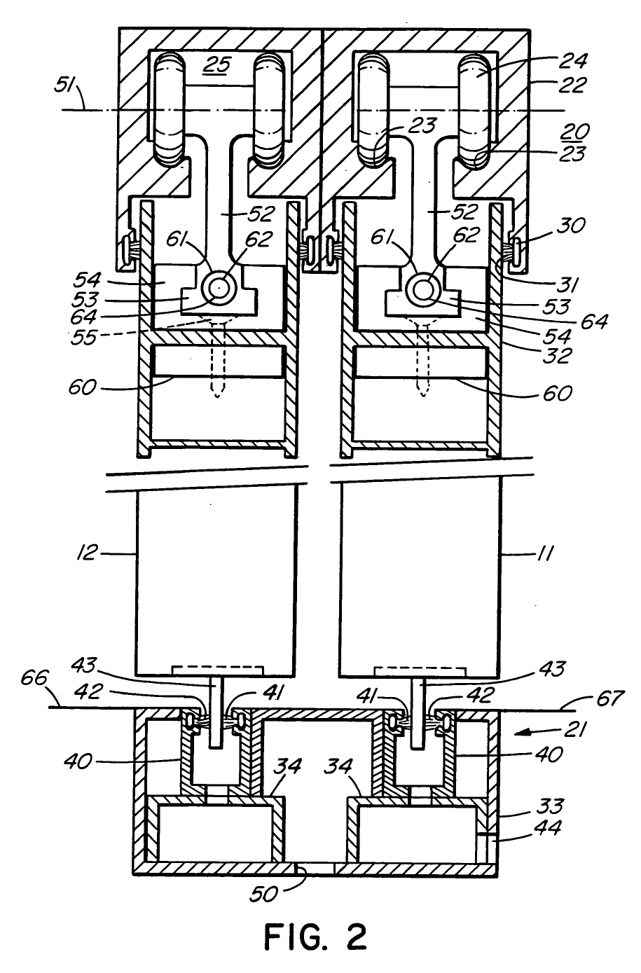

Referring now to the drawings, a set of sliding doors, in this case, two (2) such doors 11, 12 is generally shown at 10 in FIG. 1. The first and second doors 11, 12, respectively, move within respective guide strips 13, 14 and are each hung from a pair of upper hanging assemblies, one such hanging assembly being generally illustrated in detail at 20. A lower guide or sill assembly is generally illustrated at 21 in FIG. 2, it being understood that the upper hanging assemblies 20 and the lower guide or sill assembly 21 are the same for each of the sliding doors 11, 12.

A support bracket conveniently in the form of an aluminum extrusion 22 is mounted in the frame of the house or other structure (not shown). The support bracket 22 includes two (2) bearing guide paths 23 to allow the rotating bearings 24 of the bearing assembly 20 to move therein as will be described. The support bracket 22 also conveniently includes brush housings 30 which hold removable mohair brushes 31 used to provide a brushing action against the top frame member 32 of door 11 and thereby to prevent the ingress of water and debris and to remove loose foreign material from the door 11 during the sliding operation.

A second extrusion, conveniently a plastic drain tube 33, is similarly mounted in the frame of the house or other structure and forms the principal member of the sill assembly 21. The drain tube 33 contains side drain holes 44 and/or bottom drain holes 50 to allow the drainage of moisture and other debris to the outside environment. The drain tube 33 also allows for the entrance and retention of several shims or ribs 34. The shims 34 (FIG. 2) extend perpendicular to the longitudinal axis of the drain tube 33 and are relatively narrow. The shims 34 provide support for the guide strips 40 which are removably mounted on the shims 34 and within the drain tube 33. The guide strips 40 also contain brush housings 41 which allow the entry of removable mohair brushes 42. The brushes 42 bear on a guide or key 43 which is connected to the lower portion of the door 11 and which guide or key 43 provides a degree of stability during the sliding movement of the panel members 11, 12. The guide 43 extends substantially the entire length of the bottom of the door 11 and may take the form of a T-section which is bolted to the bottom of the door 11 at several different locations to ensure connection integrity. It will be noted that the upper surface of the drain tube 33 may conveniently be level with both the interior and exterior floor surfaces 66, 67 thereby allowing carts, wheelchairs and the like to easily move along the floor surfaces 66, 67 and over the top of the drain tube 66 without difficulty although the upper surface may also be raised or lowered relative to the floor surfaces if desired.

The bearing assembly 25 includes the rotatable bearings 24 which are conveniently heavy duty and made from a TEFLON material in order to reduce the friction between the bearings 24 and the bearing guide paths 23 when the bearings 24 are moving within the guide paths 23. The bearings 24 conveniently number three (3) and rotate about respective axes 51. Bearings 24 are connected on each side of a hanger 52 which extends downwardly and centrally between the bearings 24 thereby to reduce or eliminate any moment acting on the bearings 24 by the hanging members 11, 12 which are each connected to the hanger 52 as will be described.

Hanger 52 terminates in an enlarged female member 53 which is mounted for reciprocal and longitudinal movement within a wedge member 54. The hanger 52 extends downwardly from the forward most bearing 24 as viewed in FIG. 1 a distance “d1” which distance “d1” is longer than the distance “d2” from the rearward one of the bearings 24 as also seen in FIG. 1. The slope between the two distances d1, d2 matches the slope of a wedge member 54 in which the female member 53 moves. Wedge member 54 is connected to an anchor plate 60 (FIGS. 1 and 2) which anchor plate 60 is mounted to the top of the door 11 and which has bolts 55 extending there through. Wedge member 54 therefore moves with door 11 and anchor plate 60 and remains stationary relative to the door 11 and anchor plate 60.

A threaded hole 61 extends through the female member 53 of hanger 52 and a threaded bolt 62 is threadedly connected through hole 61. A socket 64 in the end of the threaded bolt 62 allows the entry of a complementary matching member on the end of a tool (not shown) which is used to rotate the bolt 62. The bolt 62 is held by a collar 63 mounted for stationary position within wedge member 54 which collar 63 allows the bolt 62 to rotate freely within the threaded hole 61 of wedge member 54 while not moving the bolt 62 longitudinally and thereby drawing the hanger assembly 25 along the wedge member 54 which, because of the connection between the wedge member 54 and anchor plate 60 to the door 11, allows the panel member or door 11 to be easily moved upwardly and downwardly relative to the door bearing assembly 25 and the support bracket 22 as the installation may require in order that the door 11 hangs cleanly and moves freely.

A recess 65 is provided in the support bracket or aluminum extrusion 22 at the end of the bracket 22 mounted in the frame of the moving panels 11, 12 (FIG. 1). It will be understood that a further and second recess 64 is provided at the opposite end of the support bracket 22 which is not illustrated in FIG. 1. The recess 65 is formed by cutting away material previously forming the bearing guide paths 23 formed on either side of the longitudinal axis of the bracket 22. By removing the guide path material to form the recess 65, the bearing assembly 25 is easily inserted into the support bracket 22 and the bearings 24 can then move freely on the bearing guide paths 23. To prevent the bearings 24 from moving into the recess 65 during sliding movement and operation of the door 11, the wedge member 54 and anchor plate 60 are mounted to the door 11 at a position where, with the door 11 in its limiting positions of movement within lower drain tube 33 and upper support bracket 22, the bearings 24 remain a distance away from the recess 65 thereby avoiding any unnecessary stress in the bearing guide paths 23 adjacent the recess 65 and thereby avoiding the recess 65 entirely.

### OPERATION

In operation, it will be assumed that the upper support bracket 22 and the lower drain tube 33 have been installed in the frame of the structure into which the sliding panel or door assembly 10 is to be installed and that it is now intended to install the panel or door assembly 10 (FIG. 1).

The anchor plates 60, one for each of the bearing assemblies 25, which bearing assemblies 25 are mounted at opposite ends of each panel or door 11, are mounted to the top of each of the doors 11, 12 as seen in FIG. 1 and the key member 43 is attached to the bottom of the doors 11, 12 again by bolting the key member 43 to the door 11. The wedge members 54 are then connected to the anchor plates 60 by bolts 71 extending into the anchor plates 60. One wedge member 54 is mounted to each of the anchor plates 60; that is, one anchor plate 60 and one wedge member 54 are mounted to each end of each door 11, 12.

The lower guide strips 40 will be placed into position within drain tube 33 and will rest on the shims 34, the shims 34 being placed perpendicular to the longitudinal axis of the drain tube 33 and spaced intermittently along its length.

The doors 11, 12 will then be manually moved into their general installation position by placing the key 43 on the bottom of the door 11 into the guide strip 40 and allowing the door 11 to remain substantially vertically in its resting position on the drain tube 33. The top of the door 11 will be inserted into and retained by the sides of the support bracket 22 to prevent the door 11 from moving sidewardly and falling from its temporary and upright position.

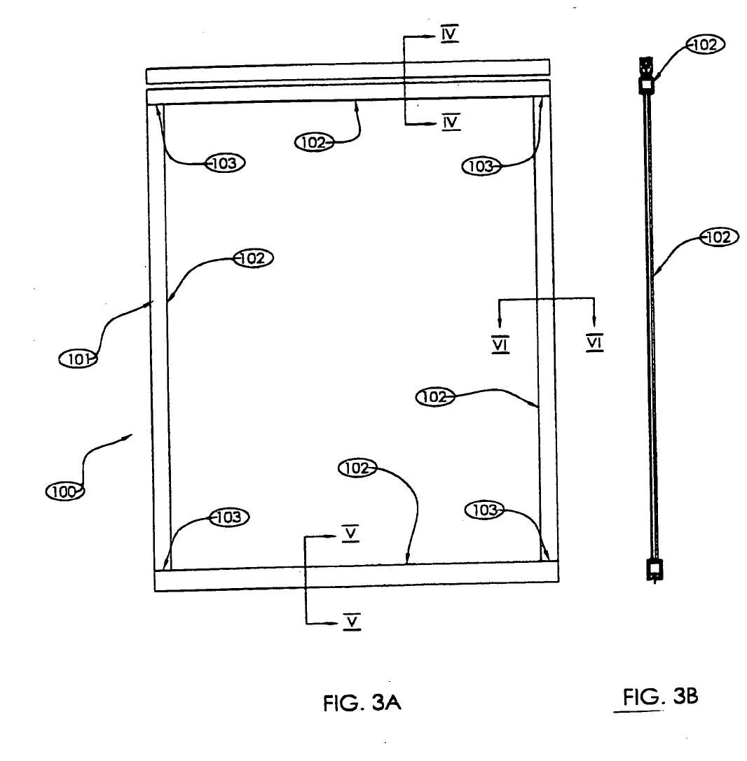

An installer will then begin the final hanging. The installer will insert a bearing assembly 25 into each of the wedge assemblies 54 by inserting the rotating bearings 24 into the guide paths 23 through the recess 64 (FIG. 1). He will then move the door 11 until the hanger 52 and male member 53 are aligned with the recess 72 in the wedge member 54 (FIG. 3A) and the bolt 62 is rotated with the installation tool (not shown) which rotates the bolt 62 through its end socket 64 until the wedge assembly is fully engaged. A similar procedure will take place between the second bearing assembly 25 and the second wedge member 54 at the opposite end of the door 11. The installer will then raise or lower the door 11 relative to the guide paths 23 by appropriately rotating the bolt 62 at each end of the door 11 so that the key 43 reciprocates freely within the guide strips 40 with the mohair brushes 42 suitably brushing the key 43 as the movement of the door 11 takes place and so that the door 11 is suitably level within the upper extrusion 22 and so that the vertical ends 73 of the door 11 match the vertical sides (not shown) of the door frame.

It will be appreciated that the bearings 24 act on either side of the longitudinal axis 70 of the upper support bracket 22 and that the door 11 hangs vertically from the hanger 52 which is connected to the bearings 24. Thus, the weight of the door 11 acts generally vertically downwardly and generates little if any moment on the bearings 24 and bearing assembly 25. The key 43 thereby also moves freely within the guide strips 40 and allows the mohair brushes 40 to brush debris and foreign material off the key 43 which debris is disposed of through the bottom and side drain holes 50, 44, respectively, in the drain tube 33. The key 43 also serves to block the egress of wind and water driven from the outside environment. Any such wind, water or debris will fall into the guide strips 40, thence to the guide tube 33 and out to the outside via drain tubes 44, 50.

The use of the wedge member 54 to move the door 11 upwards and downwards will allow a single installer to provide the finished door installation in which the door 11 may be centered and raised or lowered as necessary so the loading of the door 11 will fall on the bearings 24 of the bearing assembly 25 and so that the door 11 may be appropriated fitted within the door frame to provide a close matching fit with the door frame. The panel or door members 11, 12 may also be easily raised relative to the guide tube 33 by a user using the described tool to rotate bolt 62 and thereby raise the panel members 11, 12 relative to the guide tube 33. If the user intends to clean the guide tube 33 and drain tubes 40 of the sill assembly 21, it is convenient to do so without the necessity of removing the heavy door or panels 11, 12. All the members making up the sill assembly 21 can be easily replaced if necessary.

Many modifications will readily occur to those skilled in the art to which the invention relates. For example, the use of relative movement between the wedge member 54 and the bearing assembly 25 so as to lift and lower the door 11 relative to the extrusion 22 may suitably be modified by allowing the bearing assembly 25 to remain stationary relative to the door 11 and by moving the wedge member 54 relative to the door 11 and bearing assembly 25. All that is needed is relative movement between the bearing assembly 25 and the wedge member 54 in order to provide the necessary adjustment. Likewise, while it is apparent that the use of heavy sliding doors, used in exteriorly exposed position, will most often make use of the invention, it is intended to cover sliding panel members as well.

It is further contemplated that, of course, portions of the sill assembly can be raised if desired such that the sill assembly may project above the surfaces of the exterior and interior floors.

A further embodiment of the invention is illustrated in FIGS. 3-6 which collectively illustrate a thermally broken panel system generally illustrated at 100. This door system 100 conveniently utilizes a steel core 101 which provides rigidity and strength against exterior wind-loading pressures and which steel core 101 is made possible because of the hanging door assembly also described and illustrated herein. The steel core 101 extends around the circumference of the panel 100 as best seen in FIG. 3. The steel core 101 comprises four separate members 102 which are welded together at the end portions 103 to form a substantially continuous periphery of the panel system 100. The dimensions of the steel core 101 can, of course, be varied depending on the structural loading requirements which may be affected by environmental considerations such as wind exposure.

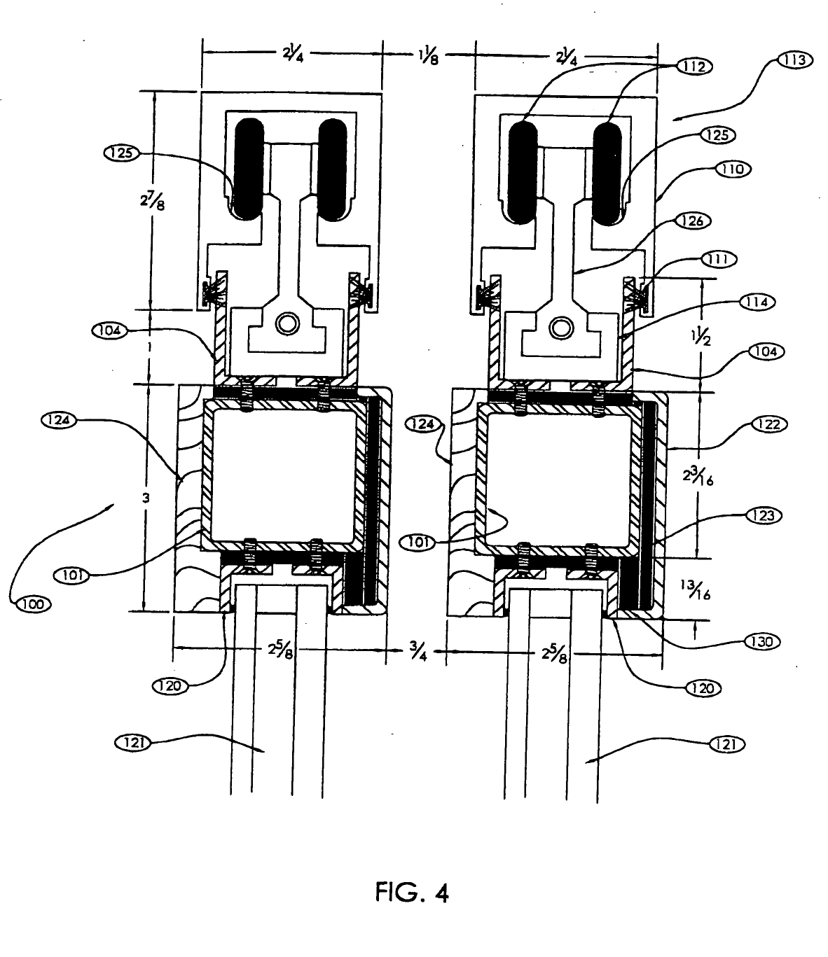

The top of each of the sliding door panels 100 is seen in detail in FIG. 4. A U-shaped bracket 104 is connected to the upper surface of steel core 101 as by bolts, screws or other known techniques. The U-shaped bracket 104 is designed to run within an aluminum extrusion 110 which is connected to the top of the door frame (not illustrated) and which includes mohair brushes 111 which brush the bracket 104 and which act as weather seals when the panels 100 are in a closed position. A hanging assembly generally illustrated at 113 includes a multiple number of wheeled trucks 126 which run on tracks 125 within the aluminum extrusion 110 which tracks 125, trucks 126 and wheels 112 of trucks 126 allow the panel systems 100 smooth movement relative to the aluminum extrusion 110. The hanging assembly 113 is connected to a further extrusion 114 which is fixedly mounted within the U-shaped bracket 104 with bolts or screws (not illustrated).

A bottom aluminum extrusion 120 is mounted beneath the steel core 101 as seen in FIG. 4. This extrusion 120 serves as the upper female member for receiving the upper or top of the sealed window or solid panel 121.

An outside piece of clad aluminum material 122 is fitted to extend horizontally the length of the panel 100 and to cover the steel core 101. The clad aluminum material 122 is exposed to outside weather conditions and it is therefore intended to be of relatively robust construction. An insulating member, conveniently made from polyvinyl chloride (PVC) material 123, is positioned between the steel core 101, upper U-shaped bracket 104 and lower U-shaped extrusion 120 and the outside clad aluminum material 123. The insulating member 123 isolates the temperature of the clad aluminum material 122 from the steel core 101, the upper U-shaped bracket 104 and the bottom extrusion 120.

A preferred interior or inside material, conveniently wood, granite, marble or other attractive material 124 is mounted directly to the steel core 101 and extends downwardly to conceal lower U-shaped extrusion 120 and upper U-shaped bracket 104. Because of the thermal barrier in the form of the PVC spacer 123 between the outside cladding 123 and the steel core 101, the interior material 124 is isolated from the outside temperatures with the result that it is exposed to interior temperatures only and will not suffer from the exterior weather conditions which would otherwise dictate against the use of the desired inside material. The PVC insulating material 130 may also be positioned between the PVC spacer 123 and conveniently, if desired, between the lower extrusion 120 and between the interior material 124 and the lower extrusion 120 as is illustrated.

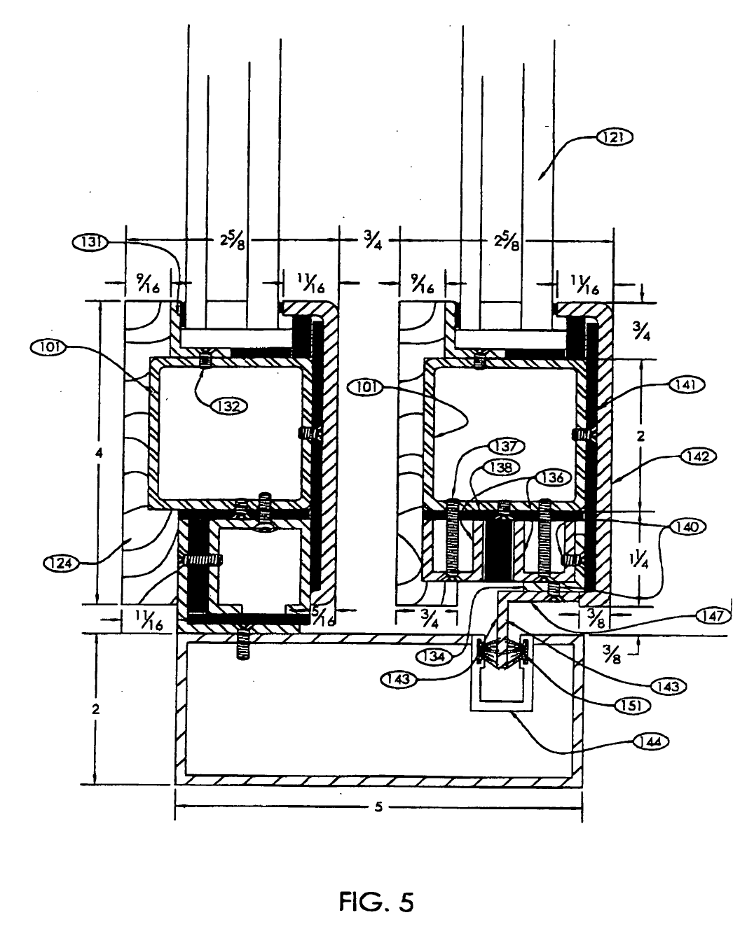

Referring to FIG. 5, the assembly of the bottom of the panel system 100 is similar to that of the upper portion of the panel system described in relation to FIG. 4. The window 121 is fitted into a lower L-shaped extrusion 131 which is mounted to the steel core 101, conveniently with the use of bolts 132. The interior material 124 is likewise connected directly to the steel core 101, conveniently by gluing or by clips or other appropriate connecting technique. The sliding panel 121 one of the pair of the two assemblies illustrated in FIG. 5 has a pair of U-shaped members 136 connected to the steel core 101 with bolts 137 and with a PVC layer 138 positioned between the core 101 and the pair of U-members 136. An angle 134 is connected to the U-shaped member 136 using screws 140 and a spacer made from PVC material 141 is positioned outside the angle 134 to serve the aforementioned insulating function and runs substantially the height and length of cladding 131. The exterior cladding 142 runs into an angle 147 which has a leg 143 extending into a continuous guide 144 which is positioned within the finished floor 150 of the structure in which the panel system 100 is to be installed. Mohair brushes 151 using continuous vinyl seals brush the leg 143 to prevent the ingress of floor detritus and water contamination and to maintain the leg 143 in a generally full time vertical orientation during operation. Insulating material 151, conveniently PVC, is positioned between the U-shaped members 136 and also between the steel core 101 and the U-shaped members 136 as has been described.

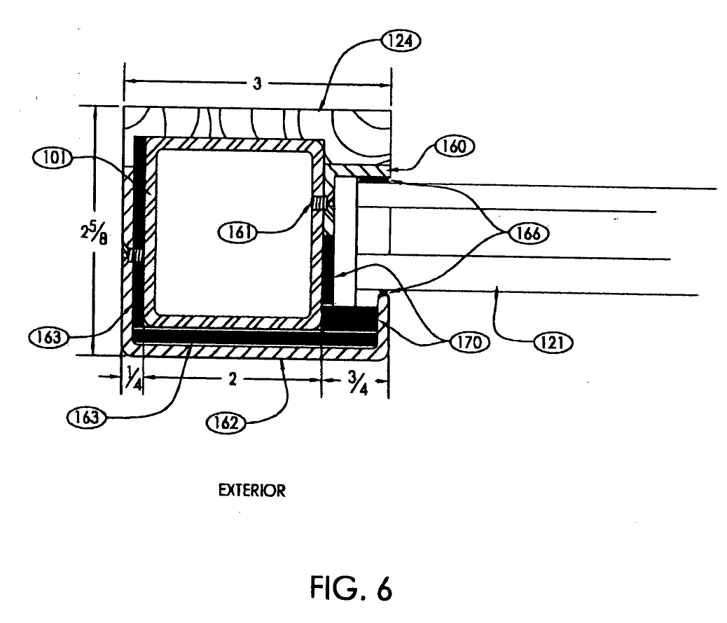

Referring to FIG. 6, the vertical portion of steel core 101 is shown with a similar construction to that described in association with FIGS. 4 and 5. A steel or aluminum extrusion (not illustrated) is conveniently mounted directly to a concrete wall (not illustrated) of the structure in which the panel system 100 is installed. The interior material 124 is mounted directly to the steel core 101 and an angle 160 is connected directly to the steel core 101 with the use of screws 161. Angle 160 accommodates the entry of the window 121 and seals and silicon 166 is provided between the panels 121 and angle 160. The outside cladding material 162 is formed to extend from the window 121 to the interior material 124 and a PVC spacer 163 extends vertically in contact with the steel core 101 and between the steel core 101 and the outside cladding 162 as is illustrated. Additional insulating material 170 may conveniently be positioned between the classing 162 and the steel core 101 and between the steel core 101 and the panel or window 121 as is illustrated.

For ease of transport and handling, the welded steel cores 101 can be shipped and installed as skeleton frames. The thermal breaks or PVC insulating material described can be applied on-site since they are surface applied and the necessity for a crane to lift the material is obviated which is useful in sites which may be inaccessible to a crane or where weight considerations are important.

Various interior and exterior cladding options are available since the interior and exterior cladding are thermally isolated from each other and despite the variation of coefficients of thermal expansion of the different materials, such different materials may readily be utilized according to the desires of the user or designer. Similarly, although the system is particularly advantageous and has been described in association with windows, it is clear that the system is useful for non-window movable panels or a combination of solid wall panels as well as windows. Likewise, although the insulating material has been described as a PVC material, many other such materials may also readily be used such as LEXAN (Trademark).

Many further modifications will readily occur to those skilled in the art to which the invention relates and the particular embodiments herein described should be taken as illustrative of the invention only and not as limiting its scope as defined in accordance with the accompanying claims.

I claim:

1. A hanging panel system having at least one panel which moves in a substantially horizontal plane with said panel in a substantially vertical position, said panel system having a hanging assembly on the upper end of said movable panel to allow said movement in said substantially horizontal plane, said panel member having a load bearing member extending around the circumference of said panel, said panel having an outside and an inside surface, said outside surface being thermally isolated from said load bearing member and said inside surface, said load bearing member being made from steel material.

2. A hanging panel system as in claim 1 wherein said load bearing member is quadrilateral member.

3. A hanging panel system as in claim 2 wherein said quadrilateral member is square in cross-section.

4. A hanging panel system as in claim 1 wherein said outside surface is defined by a first material having a first coefficient of expansion and said inside surface is defined by a second material having a second coefficient of expansion, said first and second coefficients of expansion being different.

5. A hanging panel system as in claim 1 wherein said load bearing member is an I-bead with outside flanges parallel to said outside and inside surfaces.

6. A hanging panel system as in claim 1 wherein said outside surface is defined by a metal cladding material.

7. A hanging panel system as in claim 6 wherein said metal cladding material is aluminum material.

8. A hanging panel system as in claim 6 wherein said inside surface is defined by a material different from said material which defines said outside surface.

9. A hanging panel system as in claim 8 wherein said material defining said inside surface is one of wood, granite, marble or stone.

10. A hanging panel system as in claim 1 and further comprising a window.

11. A hanging panel as in claim 1 wherein said outside surface is defined by a copper, wood or bronze material.

12. Method of manufacturing a hanging panel member operable to be connected to a hanging and movable bearing assembly, said method comprising the steps of locating a load bearing member so as to define the general circumference of said panel member, operatively connecting an inside and an outside surface material to said load bearing member, thermally isolating said outside surface material from said load bearing member and said inside surface material and utilizing steel material for said load bearing member.

13. Method as in claim 12 wherein said inside surface material is granite, wood, marble, stone or metal.

14. Method as in claim 13 wherein said outside surface material is metal cladding.

15. Method as in claim 14 wherein said metal cladding includes bronze, copper, aluminum, zinc or steel sheeting.
